(19) United States
(12) Patent Application Publication
(10) Pub. No.: US 2005/0165710 A1
(43) Pub. Date: Jul. 28, 2005

(54) Network-info device

(75) Inventor: Ofer Givaty, Misgav (IL)

Correspondence Address: Unocon;Noam Ribon, 2394 Timbercrest Court, Ann Arbor, MI, 48105, US

(73) Assignee: UNOCon LLC c/o Noam Ribon, Plymouth, MI (US)

(21) Appl. No.: 10/504,440

(22) PCT Filed: Feb. 17, 2003
(86) PCT No.: PCT/IL03/00122

(30) Foreign Application Priority Data
Feb. 18, 2002 (IL) 148224

(51) Int. Cl. G06F 17/30

(52) U.S. Cl. 707/1

(57) ABSTRACT

A network-info device, said device comprising of: (a) a connection means, enables to connect said device to a transmission media channel of a network or to any other transmission media means of a network including wire, cable, optical fiber and other transmission means and wherein said connection can be done on an existing transmission means or while producing said transmission means or while producing a connection accessories for said transmission means; (b) a memory; and (c) a communication means. The invention additionally relates to a system and a method to manage network information by using said device.

### FIELD OF THE INVENTION

The present invention relates to a device, a system and a method for documenting, using and managing network information. More specifically, the present invention relates to a device to be installed in network nodes, wherein this device holds information and has a communication capability. Moreover, the present invention relates to a system and a method to manage network information by using this device.

### BACKGROUND OF THE INVENTION

Modem physical networks can become very complicated. A physical network is a construct of connector means and transmission media means that are connected to one another creating channels of multiple such connections nodes. Each such channel connects a generator/source of the energy to a recipient/client of the energy. The higher the number of channels and/or nodes in a specific network is, the more connectors and cables are required (i.e. Ethernet standards allow for 5 connectors and 4 medium segments per channel) creating a more complicated topology. A physical network topology can end up with thousands of connectors and transmission media segments with an even larger set of possible connection combinations between them.

Lack of on-demand, readily available and simple to use documentation of these complicated networks and their topologies effect the ability to efficiently, effectively and economically install, use, maintain, control and manage such networks. Documenting a physical network includes records of the topology of the network (who is connected to who), the map of physical channels (how is each channel routed), the connectors participating in a channel (including: location, wiring, type, manufacturer and other attributes), the transmission mediums used to connect between connectors and their attributes, maintenance records (i.e. performance, history, technician) and multiple more attributes information. Overall that can lead to a large set of information that is hard to collect, expensive to manage and maintain, and even more difficult to sort when a need occurs at any place/node (e.g. troubleshooting) on the network. On the other hand accurate and timely information is required by the professionals involved in the total life cycle of a physical network for the tasks they perform, at the time of need and place of execution (i.e. on-demand).

The most technically advanced solutions are logical software database tools with customized user interface to support the specific physical network documentation application. A few of these solutions provide some physical means to identify a change to the current connectivity state (usually a disconnection) and enforce a modification to the database. Nevertheless, these means are focused on either a cross-connect area or the edge nodes area of the physical network. Almost exclusively these means use a low current power loop to indicate a connection and a break in the current loop to signal a disconnection event. The current loop is sometimes created within the connecting cable or on external additional wire/s (i.e., U.S. Pat. No. 5,195,902 to Bengal and U.S. Pat. No. 5,161,988 to Krupka). Other attempts are made with external (to the physical network) identifiers that when used are designed to be attached to assets that connect to a physical network (U.S. Pat. No. 6,177,860 to Cromer et al. and U.S. Pat. No. 6,046,676 to Ward and Maletsky). This class of solution attempts to resolve asset management problem and provides what might be important, but partial information that requires a massive set-up.

Whether supported by one of these advanced solutions or not, the state of the art practices are cumbersome and the tools are complicated to use and expensive to operate and in some cases to acquire. Most advanced technologies solutions prove to be not price or resource effective to resolve a problem that is not strategic and that end users expect will be resolved with-in their current processes and without additional effort or resources on their side. When not utilizing such tools, the common practices are based on collecting information through required documents and job-order precession basis. Many times an organization finds itself dependent on key personnel memory when it comes to their physical network. While a cheaper option, it hardly proves effective and economical at times of need.

The solution that is provided by the present invention enables locating a specific nodes' information onto and at the node itself. Whenever the information is needed, it can be received from/at the node. Using the present innovation, nodes' information is obtained in real time, on demand and either centrally or at the place it is required. Updates and modifications are made centrally or at each node at the same time a change takes place. Information management tasks are minimized paper work and complicated reconciliation tasks are eliminated.

### SUMMARY OF THE INVENTION

The present invention is a network-info device, interactive connector and a method for managing a network by using this device.

According to the teachings of the present invention there is provided a network-info device, the device comprising of:
a connection means, enables to connect the device to a transmission media channel of a network or to any other transmission media means of a network including wire, cable, optical fiber and other transmission means and wherein the connection can be done on an existing transmission means or while producing the transmission means or while producing a connection accessories for the transmission means;
a memory; and
a communication means.

According to further features in the described preferred embodiment the network-info device further includes an electronic and computing unit.

In a preferred embodiment, the electronic and computing unit of the device, according to the present invention, is operative fore:
recognizing a demand for information from the memory, wherein the demand arrives via the communication means;
reading information from the memory, according to the demand; and
transferring the read information, via the communication means, to the address that the demand was received from.

In another preferred embodiment, the electronic and computing unit of the device, according to the present invention, is further operative fore:
receiving update-information via the communication means and update the information of the memory; or
receiving update-information via the communication means and modifies the configuration of the node where the device is connected-on.

In another preferred embodiment, the electronic and computing unit of the device, according to the present invention, is further operative fore:
recognizing events that occur in the node where the device is connected-on and saves information according to the events in the memory and wherein the events include—inter alia—time and duration of transmissions through the node, disconnection and reduction of the transmission quality.

In another preferred embodiment, the electronic and computing unit of the device, according to the present invention, is further operative fore:
sending an alert message, according to a predetermined events' criteria, to a predetermined address.

In another preferred embodiment, the network-info device is integrated with or in a connecting means or an adapting means that are used in nodes of a network in order to connect transmission media such as wire, cable, fiber-optic or any other network transmission media.

In another preferred embodiment, the network-info device is integrated or built-on with a connection device or a communication device of a network subscriber.

In another preferred embodiment, the communication means of the network-info device—according to the present invention—enables communication through the network either by using the network protocol or by using other protocol.

In another preferred embodiment, the communication means of the network-info device—according to the present invention—is a wireless communication means, enables wireless communication with a communication accessory and wherein the wireless communication is RF communication, IR communication or any other wireless communication.

In another preferred embodiment, the communication means of the network-info device—according to the present invention—is a smart chip that is using RFID technology and/or in-line communication technologies.

In another preferred embodiment, the communication means of the network-info device—according to the present invention—has a network communication capability, enables communication via the connected-on network with any subscriber or server that is connected to the network.

In another preferred embodiment, the communication means of the network-info device—according to the present invention—enables communication with an external accessory that is connected to the network.

In yet another preferred embodiment, the memory of the network-info device—holds information and wherein the information includes—inter alia—information and details regarding to the node, which the device is connected-on and wherein the information can be read and can be updated via the communication means.

By another aspect of the present invention there is provided a interactive-connector, comprising of:
connection means;
a memory; and
a communication means.

In a preferred embodiment there is provided, according to the present invention, the interactive-connector, wherein the communication means has Ethernet-network communication capability.

In another preferred embodiment the electronic and computing unit, or part of the electronic and computing unit, is a smart chip, the smart chip is using contact and/or contactless communication technology.

In another preferred embodiment the electronic and computing unit is an integral part of the interactive-connector.

In another preferred embodiment the electronic and computing unit is added on to a interactive-connector that is used in a network for connecting transmission media such as, wire, cable, fiber optic or any other network transmission media.

In yet another preferred embodiment the electronic and computing unit is operative for:
recognizing a demand for information from the memory, wherein the demand arrives via the communication means;
reading information from the memory, according to the demand; and
transferring the read information, via the communication means, to the address that the demand was received from.

In another preferred embodiment the electronic and computing unit is operative for:
receiving update-information via the communication means and update the information of the memory; or
receiving update-information via the communication means and modifies the configuration of the point where the interactive-connector is connected-on.

In another preferred embodiment the electronic and computing unit is further operative for manipulating the information as coded, before transferring the information.

In another preferred embodiment the electronic and computing unit is further operative for:
recognizing events that occur in the node where the interactive-connector is connected-on and saves information according to the events in the memory and wherein the events include—inter alia—time and duration of transmissions through the node, disconnection and reduction of the transmission quality.

In another preferred embodiment the electronic and computing unit is further operative for:
configuring and sending an alert message, according to a predetermined events' criteria, to a predetermined address.

In another preferred embodiment the electronic and computing unit is further operative for recognizing the type of subscriber that the interactive-connector is connected to and is capable to interfacing electrical power whenever the subscriber needs an electrical power.

In another preferred embodiment, the interactive-connector—according to the present invention—is a wire interactive-connector, a cable interactive-connector, a fiber optic interactive-connector or any other network transmission media interactive-connector.

In another preferred embodiment, the communication means of the interactive-connector—according to the present invention—is a wireless communication means, enables wireless communication with a communication accessory and wherein the wireless communication is RF communication, IR communication or any other wireless communication.

In another preferred embodiment, the communication means of the interactive-connector is a smart chip that is using RFID technology and/or in-line communication technologies.

In another preferred embodiment, the communication means of the interactive-connector has a network communication capability, enables communication via the connected-on network with any subscriber or server that is connected to the network.

In another preferred embodiment, the communication means of the interactive-connector enables communication with an external accessory that is connected to the network.

In another preferred embodiment the memory of the interactive-connector—according to the present invention—holds information and wherein the information includes—inter alia—information and details regarding to the node, which the device is connected-on and wherein the information can be read and can be updated via the communication means.

By yet another aspect of the present invention, there is provided a network-information managing system, inter alia enables distribution of information to each node of a network wherein the information is available on demand locally at the node and enables remote interaction with each of the nodes for modifying the data or updating the configuration. The managing system is comprised of:
one or a plurality of network-info devices, wherein each of the network-info devices are located in each node of a network either attached to a transmission media, are integrated with or on a interactive-connector or are installed in a network-connection means of a subscriber, and wherein the network-info device includes:
   a memory, the memory holds information regarding to the connecting node or the junction;
   an electronic and computing unit, enables reading information from the memory and updating the information in the memory; and
   a communication means; and
a corresponding system that has the capability to communicate with each of the network-info devices via the communication means in order to read and display the information that received from the memory of a specific network-info device and in order to update the information in the specific network-info device.

In one preferred embodiment, there is provided the network-information managing system, wherein the corresponding system is an accessory that is connected to the network or an accessory that has a wireless communication capable to communicate with the communication means, or a software system installed in a network subscriber, or server, or a combination of the accessories and/or the software.

In another preferred embodiment, there is provided the network-information managing system, wherein the network-info device provides real-time central reporting of one or plurality of the node status and capable to update—in real time—one or plurality of the nodes status.

In another preferred embodiment, there is provided the network-information managing system, wherein the network is used for Ethernet protocol communication.

By yet another aspect of the present invention, there is provided a method for managing network information comprising of:
locating a network-info device connected to each connecting node and junction of a network, wherein the network-info device includes a memory and a communication capability;
storing specific information, regarding to each specific node or junction, in the memory of each specific network-info device;
updating the specific information whenever it is needed; and
using a corresponding accessory or system to read a specific piece of information from a specific connecting node or junction from the memory of the network-info device.

In one preferred embodiment, there is provided the method for managing network information, wherein the network-info devices are integrated with or in the interactive-connectors that are used in the connection nodes.

The present invention successfully addresses the shortcomings of the existing technologies by providing a network-info device and a method for managing a network by using this device. The device of the present invention is simple, reliable, inexpensive, and can be installed in any network.

### BRIEF DESCRIPTION OF THE FIGURES

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the figures:

FIG. 1 illustrates an embodiment of a network-info device.

FIG. 2 illustrates several locations alternatives of a network-info device.

FIG. 3 illustrates an interactive-connector, which is a network-info device and a connector, wherein the elements of the device are integrated with the connector as a single unit.

FIG. 4 is a schematic illustration of a network wherein the Interactive-connectors are as described in FIG. 3 with accessories that enable to communicate with the Interactive-connectors.

### DESCRIPTION OF THE PREFERED EMBODIMENTS

The present invention is a network-info device, an interactive-connector, a system and a method for documenting and managing a network by using this device.

In a preferred embodiment the network-info device is the interactive-connector that is used to connect the network transmission medias to create channels to connect the network subscribers and service providers. Interactive-connectors are located in some or all of the nodes of the network and each interactive-connector holds, in a memory, the relevant information concerning with its node. Each interactive-connector has a communication unit that enables communication between the interactive-connector and a dedicated device or software, in a contact or contactless manner.

When maintenance is needed, the communication capability is used to first read the stored information from a specific interactive-connector about the node where it is located on and than write the new information based on the nature of the maintenance activity. In the same manner, updating or modifying a specific node is possible.

The communication with an interactive-connector can be done in a plurality of ways. For example, the communication can be done through the network by using the network native protocol or a propriety protocol, the communication can be done with software that is installed in a server or any subscriber of the network or with an external device that connected, for this purpose, to the network. Moreover, the interactive-connector can have a wireless communication capability and the communication between the interactive-connector and a dedicated device is done by contactless wireless communication such RF, IR or any other wireless communication.

The principles and operation of the network-info device and the interactive-connector according to the present invention may be better understood with reference to the drawing and the accompanying description.

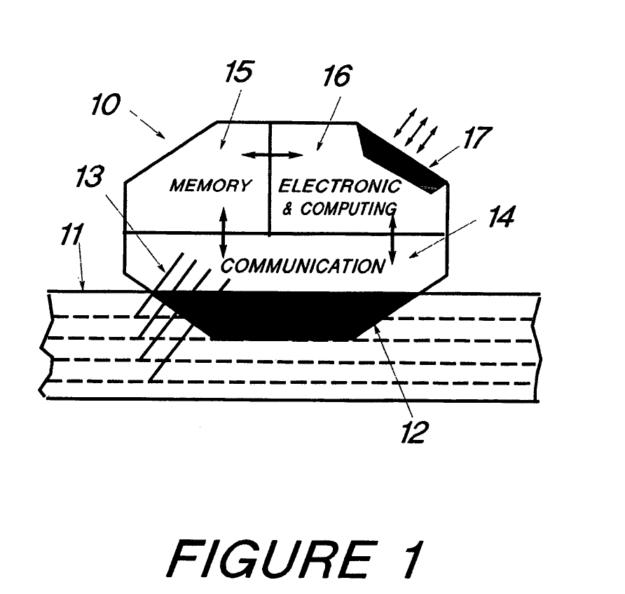

Referring now to the drawing, FIG. 1 illustrates an embodiment of a network-info device. A network-info device 10 is connected to a network cable 11 by a connection means 12 and there is a physical connection 13 between the transmission medias of the cable 11 and the units of the network-info device 10. The network-info device 10 includes a communication unit 14, a memory 15, and an electronic and computing unit 16. The device can includes a transmission means 17 such as electromagnetic antenna or IR interface for wireless communication. The network-info device 10 is connected on a network node and holds in the memory 15 information regarding to the node that the device connected on. This information is available at any time and can be demanded by using the communication unit 14 that receives information from the memory 15 or sends information to update it. The communication with the network-info device can be established via the network cable 11 through the physical connection 13 or by wireless communication, using the transmission means 17. The electronic and computing unit 16 is used for several tasks, for example; to update or modify a node, for communicating and updating the memory 15, for recognizing events in the node and hold events' history in the memory 15 or for sending messages to a predetermined address according to a predetermined criteria.

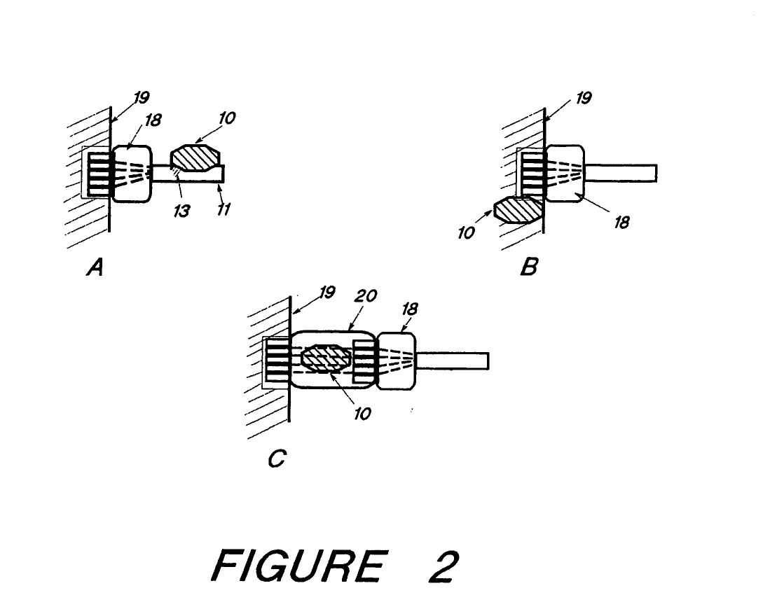

FIG. 2 illustrates several locations where a network-info device can be located. Preferably, the network-info device 10 is located near a network node, usually where the network connector 18 is mounted 19. The device 10 has a physical connection 13 with the network transmission medias and capable to communicate by using wireless communication or through the network itself—by using the native network protocol or proprietary protocol.

In a preferred embodiment (FIG. 2-A) the network-info device 10 can be located on a network cable 11 near the network connector 18. In another preferred embodiment (FIG. 2-B) the device 10 is located in the communication means of the subscriber 19, usually integrated to the port where the network connector 11 is connected in. In another preferred embodiment (FIG. 2-C) the network-info device 10 is located into an adapter 20. Such adapter 20 can be used in existing networks for saving special installations. The network connector ˜is connected to the subscriber's port 19 through the adapter 20, which includes a network-info device 10.

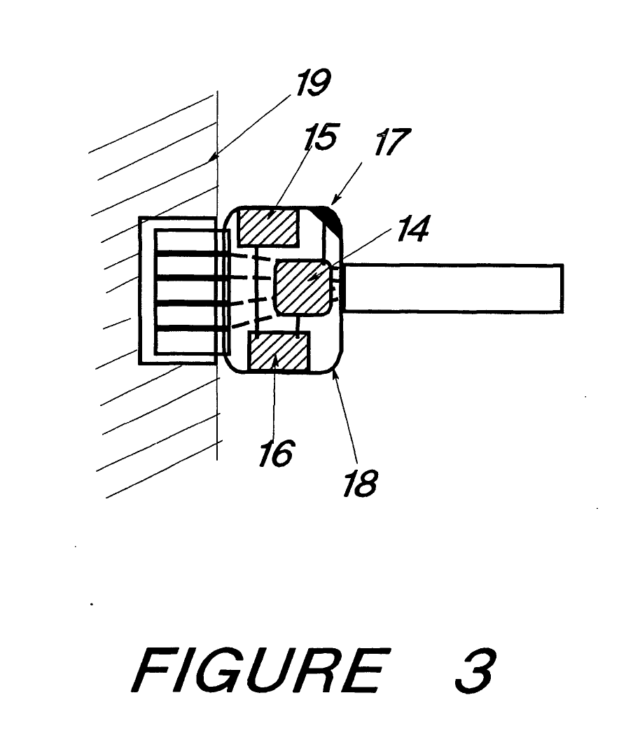

FIG. 3 illustrates an interactive-connector, which is a network-info device and a connector, wherein the elements of the device are integrated with the connector as a single unit. In a preferred embodiment, the network interactive-connector 18 is a connector and a network-info device. In other words, one interactive-connector is used as a connector and as a network-info device. The interactive-connector 18 includes a memory 15, a communication unit 14, a transmission means 17 and can include an electronic and computing unit 16. The interactive-connectors 18 connect the network transmission medias to the network ports of the subscribers 19, wherein the interactive-connector 18 is a network connecting means and a network-info device as well.

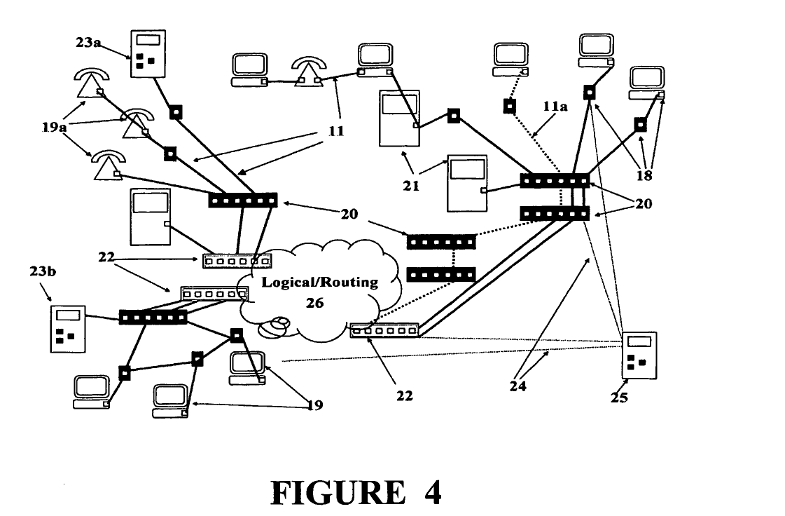

FIG. 4 is a schematic illustration of a network wherein at lest part of the connectors are interactive-connectors 18 as described in FIG. 3 and illustrates the accessories that capable to communicate with the interactive-connectors 18. A plurality of subscribers 19, telephones 19a, servers 21 and other devices are connected to a network by means of cables 11. Part of these connections are made through patch-panels 20 and routed by hubs 22. At lest part of these connections between network participators—hub 22 to patch-panel 20, patch-panel 20 to server 21 and so on—are made by means of interactive-connectors 18. Each interactive-connector 18 holds the relevant information regarding to the node where it located on.

When information is needed—whether of a specific node, a number of specific nodes or entire nodes—a communication is established with the relevant interactive-connectors 18 in order to receive the needed information. The communication with interactive-connector 18 can be established according to the present invention embodiment. The communication can be established through the network from a network server 21 or from any subscriber 19 by using dedicate software and either the native network protocol or a proprietary protocol. Connecting a dedicated accessory 23a or 23b with communication capability to the network, and using either the network protocol or proprietary protocol can establish the communication. In a preferred embodiment the interactive-connector 18 and a dedicated accessory 25 have a wireless communication capability, then a wireless communication 24 can be established between each interactive-connector 18 and the accessory 25. Each way of communication enables transferring information to and from each interactive-connector 18. A contactless accessory 25 can communicate with all interactive-connectors 28 within its range and a contact accessory 23a or 23b can communicate with all interactive-connectors 18 that are on its line. The illustrated network can be a local area network that is connected to a larger or global network 26 e.g., Internet.

As used herein in the specification and in the claims section that follows, the term “subscriber” and the like refer to any connection point such as a network subscriber, server, hub, patch panel, jack, telephone or any other device or connecting point where connectors are used.

Although the invention has been described in conjunction with specific embodiments thereof, it is evident that many alternatives, modifications and variations will be apparent to those skilled in the art, accordingly, it is intended to embrace all such alternatives, modifications and variations that fall within the spirit and broad scope of the appended claims.

1. A network-info device, said device comprising of:
(a) a connection means, enables to connect said device to a transmission media channel of a network or to any other transmission media means of a network including wire, cable, optical fiber and other transmission means and wherein said connection can be done on an existing transmission means or while producing said transmission means or while producing a connection accessories for said transmission means;
(b) a memory; and
(c) a communication means.

2. The network-info device of claim 1, further includes:
(d) an electronic and computing unit.

3. The network-info device of claim 2, wherein said electronic and computing unit is operative for:
recognizing a demand for information from said memory, wherein said demand arrives via said communication means;
reading information from said memory, according to said demand; and
transferring said read information, via said communication means, to the address that said demand was received from.

4. The network-info device of claim 3, wherein said electronic and computing unit is further operative for:
receiving update-information via said communication means and update said information of said memory; or
receiving update-information via said communication means and modifies the configuration of the point where said device is connected-on.

5. The network-info device of claim 3, wherein said electronic and computing unit is further operative for:
recognizing events that occur in the point where said device is connected-on and saves information according to said events in said memory and wherein said events include—inter alia—time and duration of transmissions through said point, disconnection and reduction of the transmission quality.

6. The network-info device of claim 3, wherein said electronic and computing unit is further operative for:
sending an alert message, according to a predetermined events' criteria, to a predetermined address.

7. The network-info device of claim 1, wherein said device is integrated with or in a connecting means or an adapting means that is used in nodes of a network in order to connect transmission media such as wire, cable, fiber optic or any other network transmission media.

8. The network-info device of claim 1, wherein said device is integrated or built-on with a connection device or a communication device of a network subscriber.

9. The network-info device of claim 1, wherein said communication means enables communication through said network either by using said network protocol or by using other protocol.

10. The network-info device of claim 1, wherein said communication means is a wireless communication means, enables wireless communication with a communication accessory and wherein said wireless communication is RF communication, IR communication or any other wireless communication.

11. The network-info device of claim 1, wherein said communication means is a smart chip that is using RFID technology and/or in-line communication technologies.

12. The network-info device of claim 1, wherein said communication means has a network communication capability, enables communication via the connected-on network with any subscriber or server that is connected to said network.

13. The network-info device of claim 12, wherein said communication means enables communication with an external accessory that is connected to the network.

14. The network-info device of claim 1, wherein said memory holds information and wherein said information includes—inter alia—information and details regarding to the point, which said device is connected-on and wherein said information can be read and can be updated via said communication means.

15. A interactive-connector, said interactive-connector comprising of:
(a) connection means;
(b) a memory; and
(c) a communication means.

16. The interactive-connector of claim 15, wherein said communication means has Ethernet-network communication capability.

17. The interactive-connector of claim 15, further includes:
(d) an electronic and computing unit.

18. The interactive-connector of claim 17, wherein said electronic and computing unit, or part of said electronic and computing unit, is a smart chip, said smart chip is using contact and/or contactless communication technology.

19. The interactive-connector of claim 17, wherein said electronic and computing unit is an integral part of said interactive-connector.

20. The interactive-connector of claim 17, wherein said electronic and computing unit is added on to a interactive-connector that is used in a network for connecting transmission media such as, wire, cable, fiber optic or any other network transmission media.

21. The interactive-connector of claim 17, wherein said electronic and computing unit is operative for:
recognizing a demand for information from said memory, wherein said demand arrives via said communication means;
reading information from said memory, according to said demand; and
transferring said read information, via said communication means, to the address that said demand was received from.

22. The interactive-connector of claim 21, wherein said electronic and computing unit is further operative for manipulating said information as coded, before transferring said information.

23. The interactive-connector of claim 17, wherein said electronic and computing unit is operative for:
receiving update-information via said communication means and update said information of said memory; or
receiving update-information via said communication means and modifies the configuration of the point where said interactive-connector is connected-on.

24. The interactive-connector of claim 17, wherein said electronic and computing unit is further operative for:
recognizing events that occur in the node where said interactive-connector is connected-on and saves information according to said events in said memory and wherein said events include—inter alia—time and duration of transmissions through said point, disconnection and reduction of the transmission quality.

25. The interactive-connector of claim 24, wherein said electronic and computing unit is further operative for:
configuring and sending an alert message, according to a predetermined events' criteria, to a predetermined address.

26. The interactive-connector of claim 17, wherein said electronic and computing unit is further operative for recognizing the type of subscriber that said interactive-connector is connected to and is capable to interfacing electrical power whenever said subscriber need an electrical power.

27. The interactive-connector of claim 15, wherein said interactive-connector is a wire interactive-connector, cable interactive-connector, fiber optic interactive-connector or any other network transmission media interactive-connector.

28. The interactive-connector claim 15, wherein said communication means is a wireless communication means, enables wireless communication with a communication accessory and wherein said wireless communication is RF communication, IR communication or any other wireless communication.

29. The interactive-connector of claim 15, wherein said communication means is a smart chip that is using RFID technology.

30. The interactive-connector of claim 15, wherein said communication means has a network communication capability, enables communication via the connected-on network with any subscriber or server that is connected to said network.

31. The interactive-connector of claim 15, wherein said communication means enables communication with an external accessory that is connected to the network.

32. The interactive-connector of claim 15, wherein said memory holds information and wherein said information includes—inter alia—information and details regarding to the point, which said device is connected-on and wherein said information can be read and can be updated via said communication means.

33. A network-information managing system, inter alia enables distribution of information to each node of a network wherein said information is available on demand locally at the node and enables remote interaction with each of said nodes for modifying data or updating configuration, said managing system is comprising of:
one or a plurality of network-info devices, wherein each of said network-info devices are located in each node of said network either attached to a transmission media, are integrated with or on a interactive-connector or are installed in a network-connection means of a subscriber, and wherein said network-info device includes:
a memory, said memory holds information regarding to said connecting node or said junction;
an electronic and computing unit, enables reading said information from said memory and updating said information in said memory; and
a communication means; and
a corresponding system, said corresponding system has the capability to communicate with each of said network-info devices via said communication means in order to read and display said information that received from said memory of a specific network-info device and in order to update said information in said specific network-info device.

34. The network-information managing system of claim 33, wherein said corresponding system is an accessory that is connected to the network or an accessory that has a wireless communication capable to communicate with said communication means or a software system installed in a network subscriber or server or a combination of said accessories and/or said software.

35. The network-information managing system of claim 33, wherein said network-info device provides real-time central reporting of one or plurality of said node status and capable to update—in real time—one or plurality of said nodes status.

36. The network-information managing system of claim 33, wherein said network is used for Ethernet protocol communication.

37. A method for managing network information comprising of:
(a) locating a network-info device connected to each connecting node and junction of a network, wherein said network-info device includes a memory and a communication capability;
(b) storing specific information, regarding to each specific node or junction, in said memory of each specific network-info device;
(c) updating said specific information whenever it is needed; and
(d) using a corresponding accessory or system to read a specific piece of information from a specific connecting node or junction from said memory of said network-info device.

38. The method for managing network information of claim 37 wherein said network-info devices are integrated with or in the interactive-connectors that are used in said connection node.
